(19) United States
(12) Patent Application Publication
(10) Pub. No.: US 2010/0098088 A1
(43) Pub. Date: Apr. 22, 2010

(54) Pseudo Wire Establishing Method and Device

(75) Inventor: Masaki Hirota, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/500,748

(22) Filed: Jul. 10, 2009

(30) Foreign Application Priority Data
Oct. 17, 2008 (JP) 2008-268917

(51) Int. Cl. H04L 12/28

(52) U.S. Cl. 370/395.5

(57) ABSTRACT

For precluding useless resources of a pseudo wire in a device distributing pseudo wires to lighten the receiving capacity, MPLS (Multi Protocol Label Switching) tunnels are established with an opposing device. From among the established MPLS tunnels, an MPLS tunnel having a remaining resource for a pseudo wire at interfaces having the MPLS tunnels in response to a pseudo wire establishment request is selected and the information of the selected MPLS tunnel associated with a label of the pseudo wire having the remaining resource is distributed to the opposing device. Alternatively after having established the MPLS tunnels with the opposing device, when a distribution request of the pseudo wire information associated with desired MPLS tunnels is received from the opposing device having received the pseudo sire establishment request, a label of the pseudo wire is similarly determined and distributed to the opposing device together with the information of the MPLS tunnel passing the pseudo wire.

### CROSS-REFERENCE TO RELATED APPLICATION

This application is related to and claims priority to Japanese Patent Application No. 2008-268917, filed on Oct. 17, 2008, in the Japanese Patent Office, and incorporated by reference.

### BACKGROUND

1. Field

The present invention relates to a pseudo wire establishing method and device and in particular to a method and device for passing a pseudo wire between opposing nodes or devices based on MPLS (Multi Protocol Label Switching) tunnels established.

2. Description of the Related Art

While MPLS has been remarkable as a recent packet transmission technology, a specification review and standardization of PWE3 (Pseudo Wire Emulation Edge-to-Edge; hereinafter referred to as pseudo wire or abbreviated as PW) offering the existing services (FR, ATM, TDM, Ethernet) over End-to-End (Point-to-Point) with a tunneling technology of MPLS have been promoted.

Through such an MPLS tunnel and pseudo wire in an MPLS network MNW between opposing nodes N1-N2 as shown in FIG. 18, a MAC frame of a main signal attached with an MPLS tunnel label (and an inter-node transfer identifier: MPLS tunnel information) and a PW label (and a PW user identifier: PW information) according to RSVP-TE (Resource Reservation Protocol-Traffic Engineering) and LDP (Label Distribution Protocol) respectively is transferred.

It is to be noted that RSVP-TE is an extended version of RSVP, known as a technology (RFC3209 etc.) for balancing communication traffic so that only a certain communication line may not be burdened.

### [1] Distribution of MPLS Tunnel Label

Distribution (assignment) of MPLS tunnel label(s) is dynamically performed between the nodes N1-N2 as described in undermentioned (1)-(5) respectively corresponding to (1)-(5) shown in FIG. 19:
(1) A management portion (Management plane: M plane) MP in a CPU board CB in the node N1 makes an establishment request for an MPLS tunnel to a control portion (Control plane: C plane) CP;
(2) The control portion CP of the node N1 sends a Path message as a label request message that is a kind of an RSVP-TE message in Downstream on Demand mode to the control portion CP of the opposing node N2 to make an MPLS label request;
(3) In response, the control portion CP of the node N2 informs the management portion MP of MPLS tunnel information stored in the Path message, whereby the management portion MP retrieves a table (not shown) provided inside the management portion MP to obtain labels of the corresponding MPLS tunnels unused;
(4) The control portion CP of the node N2 also performs the distribution of the labels of MPLS tunnel to the control portion CP of the node N1 with an Resv message in Downstream on Demand mode as noted above;
(5) The control portion CP of the node N1 notifies the MPLS tunnel label received to the management portion MP, thereby completing the establishment (setup) of the MPLS tunnels.
   [2] Distribution of PW label

On the other hand, the establishment of PW label(s) is performed as described in undermentioned (1)′-(3)′:
(1)′ The management portion MP of the node N2 retrieves an unused PW label from the present usage status of pseudo wires independently of the distribution of the above MPLS tunnel labels, and makes an establishment request of pseudo wires to the control portion CP;
(2)′ The control portion CP of the node N2 performs the distribution of a PW label to the control portion CP of the node N1 with an LDP label mapping message that is a kind of an LDP message in Downstream Unsolicited mode;
(3)′ The control portion CP of the node N1 gives the received PW label to the management portion MP, thereby passing a PW signal of a label PW1 through an MPLS tunnel T#2 established between the interfaces IF#2 as shown in FIG. 20.

Thus, between the nodes N1 and N2, MPLS tunnels and pseudo wires can be established, where the same applies to the opposite direction while the above tunnel/PW label distributions have been described and shown only for one direction.

It is to be noted that the MPLS tunnel label is determined, as described later, by negotiations between the nodes N1-N2 with respect to MPLS tunnel information (tunnel ID etc.) that is an inter-node transfer identifier, and the MPLS tunnel information substantially corresponds to the MPLS tunnel label one-on-one, so that the MPLS tunnel label is equivalent to the MPLS tunnel information while on the other hand the PW label is determined so as to be passed through the MPLS tunnel (corresponding to MPLS tunnel information) with respect to PW information (equivalent to PW ID) that is a user ID.

For a reference technology, there is a VLAN tunneling protocol in which a packet is tunneled through an LSP (Label Switched Path) according to MPLS protocol the current label value in the second switching mode from the last of LSP is replaced by a label value or the like reserved for a packet to be transmitted from a port associated with a VLAN, a packet having a label value in which an outlet switching mode of LSP is reserved is received to recognize that the VLAN information is embedded in the packet and a destination address is also taken out and transmitted to the final destination (see e.g. Japanese patent application publication 2002-247083 (US2002/0101868A1)).

Since RSVP-TE and LDP as distribution protocols respectively for MPLS tunnels and pseudo wires are independent of each other, the above processes (1)-(5) and (1)′-(3)′ are performed independently to distribute the labels used respectively (step S100 in FIGS. 20 and 21).

Namely, in the example of FIG. 20, MPLS tunnels T#1 and T#2 unused are established between the nodes N1-N2 with RSVP-TE messages M1 and M2 respectively while independently of this the node N1 assigns an unused pseudo wire label PW1 within PW information (INFO in the drawings) #A to the MPLS tunnel T#2 with an LDP message M3, and distributes it to the node N2.

In the example of FIG. 21 showing additional operations in the opposite direction to the example of FIG. 20, between the nodes N1-N2 MPLS tunnels T#1-1 and T#1-2 unused are respectively established with RSVP-TE messages M1-1 and M1-2, and MPLS tunnels T#2-1 and T#2-2 unused are respectively established with RSVP-TE messages M2-1 and M2-2.

Independently of this, by transmitting an LDP message M3-1 from the node N2, the pseudo wire label PW1 is assigned to the MPLS tunnel T#2-1 and distributed to the node N1, enabling a PW1 signal to be transmitted from the node N1 while by reversely transmitting an LDP message M3-2 from the node N1 a pseudo wire label PW2 is assigned to the MPLS tunnel T#2-2 and distributed to the node N2, enabling a PW2 signal to be transmitted from the node N2, where the pseudo wire labels PW1 and PW2 are included in the PW information #A as shown.

While in case that RSVP-TE is used for distributing MPLS tunnel labels a plurality of MPLS tunnels can be established between opposing two nodes as shown in FIGS. 20 and 21, in case that pseudo wires are passed (or distributed) between the two nodes connected with a plurality of MPLS tunnels, which MPLS tunnel a certain pseudo wire should be passed through was uniquely determined (step S200) by a node (node N1 in the example of FIG. 20) on the side of Ingress (starting point), in the past.

Namely, a node (node N2 in the example of FIG. 20) on the side of Egress (end point) permits communications with the pseudo wire by distributing the PW label, whereas which MPLS tunnel the pseudo wire is passed through is not known until the main signal actually arrives.

Therefore, the node device N2 has to prepare so as to be able to receive a pseudo wire signal from any MPLS tunnel (all tunnels T#1-1-T#2-2 in the example of FIG. 21), so that each of the interfaces (IF) is required to have a pseudo wire processing (accommodating) capacity (quantity) for overall system (step S200). The same applies to the opposite direction.

It is to be noted that the term “pseudo wire processing” here indicates the followings:
Functional aspect: PW label management/PW label table or pseudo wire related-statistical information etc.;
Physical aspect: scale of ASIC circuit, NPU/FPGA code amount, memory capacity etc.

Namely, assuming that a total number of pseudo wires which a node having 10 interfaces can accommodate is 100 for example, the node is required to treat 100 pseudo wires for each of the 10 interfaces, so that the node is required to have a very wasteful ability of accommodating 10×100=1000 pseudo wires in total.

Thus, for a receiving capacity of pseudo wires at an end node or device (Egress node) distributing pseudo wire labels, such a waste that each interface is required to have a processing capacity of overall node is caused, resulting in an cost increase of the node and a disadvantage of precluding other functions to be mounted due to a resource (bandwidth) wasted.

### SUMMARY

It is accordingly an object of the present invention to provide a pseudo wire establishing method and device which can preclude useless resources of a pseudo wire in a device distributing pseudo wires to lighten the receiving capacity.

(1) In order to achieve the above-mentioned object, there is provided a pseudo wire establishing method (or device) comprising: a first step of (or means) establishing MPLS (Multi Protocol Label Switching) tunnels with an opposing device; and a second step of (or means) selecting, from among the established MPLS tunnels, an MPLS tunnel having a remaining resource for passing a pseudo wire at interfaces having the MPLS tunnels in response to a pseudo wire establishment request, and distributing information of the selected MPLS tunnel associated with a label of the pseudo wire having the remaining resource to the opposing device.

Namely, as schematically shown in FIG. 1, it is assumed that when a device (PW receiving device: Egress node device N2) distributing a label of pseudo wire receives a pseudo wire establishment request, the Egress node N2 has a remaining resource for e.g. a label PW1 of pseudo wire information PW#A at an interface IF#2 having an MPLS tunnel T#2 among MPLS tunnels T#1 and T#2 already established as with the related art shown e.g. in FIG. 20, with an opposing device (PW transmitting device: Ingress node device) N1, based on the node N2 managing the accommodating number of pseudo wires for each interface in the CPU board CB or the like (step S1).

In this case, by associating the pseudo wire PW1 with the MPLS tunnel T#2 passing through the pseudo wire PW1 to be transmitted as a message M3 to the Ingress node N1 (step S2) and assigning an MPLS tunnel which the node N2 on the distributing side of the pseudo wire can treat to the opposing Ingress node N1, the Ingress node N1 passes the pseudo wire PW1 through the tunnel T#2 designated (step S3).

This enables the processing capacity per interface of the Egress node N2 to be reduced.

(2) Also, in the above (1), the first step (or means) may be executed by RSVP-TE (Resource Reservation Protocol-Traffic Engineering), and the second step (or means) may comprise a step of (or means) storing the information of the selected MPLS tunnel and the label of the pseudo wire associated with the information in an LDP (Label Distribution Protocol) label mapping message in Downsteam Unsolicited mode, to be distributed to the opposing device.

Namely, the distribution of PW label is prescribed according to RFC4447 of IETF such that an LDP label mapping message called Downstream Unsolicited be initiated to be used by the Egress node (PW receiving device). Also, RSVP-TE defines TLV including information (Tunnel ID) for identifying MPLS tunnels, so that upon distributing PW labels the Egress node may notify, as information of MPLS tunnel through which the Egress node desires to pass the pseudo wire, tunnel information used by RSVP-TE stored together with the label of the pseudo wire in the LDP label mapping message to the Ingress node (PW transmitting device).

(3) Also, in the above (2), the method (or device) may further comprise a third step of (or means) re-selecting, from among the established MPLS tunnels when an LDP notification message received from the opposing device in response to the LDP label mapping message indicates that the selected MPLS tunnel associated with the pseudo wire is not permitted, a second MPLS tunnel having a remaining resource for a pseudo wire at interfaces having the MPLS tunnels, and storing the information of the re-selected MPLS tunnel and the label of the pseudo wire associated with the information in the LDP label mapping message, to be distributed to the opposing device.

Namely, when the Ingress node (PW transmitting device) receives the LDP label mapping message and finds that the pseudo wire of the PW label may be passed through the MPLS tunnel designated by the Egress node, it will accept the PW label. If the Ingress node can not accept it or desires to pass the pseudo wire through a second (another) MPLS tunnel, it will notify the rejection by using the LDP notification message. The Egress node responsibly notifies again or re-notifies the information of the second MPLS tunnel to designate the second MPLS tunnel (step S3).

(4) Also, in the above (2), the method (or device) may further comprise a third step of (or means) re-selecting, from among MPLS tunnel candidates when the LDP notification message received from the opposing device in response to the LDP label mapping message indicates that the selected MPLS tunnel associated with the pseudo wire is not permitted and designates the MPLS tunnel candidates through which the pseudo wire is desired to be passed, a second MPLS tunnel having a remaining resource for a pseudo wire at interfaces having the MPLS tunnels, and storing the information of the re-selected MPLS tunnel and the label of the pseudo wire associated with the information in the LDP label mapping message, to be distributed to the opposing device.

Namely, it is possible that upon rejecting the use of the MPLS tunnel designated by the Egress node with the LDP notification message, the Ingress device notifies the Egress node of an MPLS tunnel candidate (or candidates) so that the Egress node may re-select a second MPLS tunnel among them.

(5) Also, in the above (1), the second step may comprise a step of (or means) selecting, from among the established MPLS tunnels, a plurality of MPLS tunnels respectively assigned with priorities each having a remaining resource for a pseudo wire at interfaces having the MPLS tunnels, to be distributed to the opposing device in order for the opposing device to select one of the MPLS tunnels in accordance with the priorities.

Namely, it is also possible that the Egress node transmits the information of a plurality of MPLS tunnels, assigned with respective priorities, which can pass a pseudo wire upon initially transmitting the LDP label mapping message, where the Ingress node responsively selects one of the MPLS tunnel candidates to be notified to the Egress node with the LDP notification message.

(6) Also, for achieving the above object, there is also provided a pseudo wire establishing method (or device) comprising a first step of (or means) establishing MPLS tunnels with an opposing device; and a second step of (or means) selecting, from among desired MPLS tunnels when a label distribution request for a pseudo wire to be passed through the desired MPLS tunnels is received from the opposing device having received a pseudo wire establishment request, an MPLS tunnel having a remaining resource for a pseudo wire at interfaces having the MPLS tunnels, and distributing information of the selected MPLS tunnel associated with a label of the pseudo wire having the remaining resource to the opposing device.

(7) Also, in the above (6), the first step (or means) may be executed by RSVP-TE (Resource Reservation Protocol-Traffic Engineering), and PW label distribution request may be made with an LDP label request message in Downstream on Demand mode of the original LDP, not with a message in Downstream Unsolicited mode since LDP is originally defined in RFC3036 as a protocol for distributing MPLS tunnels and then extended in RFC4447 for distributing a PW label. The second step (or means) may comprise a step of (or means) storing the information of the selected MPLS tunnel and the label of the pseudo wire associated with the information in an LDP label mapping message in Downstream Unsolicited mode, to be distributed to the opposing device.

Namely, in the above (6) and (7), before distributing a PW label with the LDP label mapping message from the Egress node to the Ingress node, a PW label request is transmitted from the Ingress node to the Egress node with the LDP label request message, in which by assigning MPLS tunnel information to the LDP label request message, the Ingress node designates an MPLS tunnel through which the pseudo wire is desired to be passed, to the Egress node.

The Egress node determines whether or not the pseudo wire may be passed through the MPLS tunnel designated by the Egress node depending on whether or not a resource of the pseudo wire at an interface having the MPLS tunnel remains, in which if it remains, the Egress node distributes the label of the pseudo wire to the Ingress node on the LDP label mapping message.

(8) Also, in the above (7), the second step (or means) may comprise a step of (or means) informing that the desired MPLS tunnel selected is not permitted if it is not permitted, to the opposing device by using the LDP notification message in order for the opposing device to re-designate another desired MPLS tunnel by using the LDP label request message.

Namely, when rejecting the MPLS tunnel, the Egress node notifies the Ingress node with the LDP notification message accordingly. The Ingress node responsively designates again another MPLS tunnel for requesting a PW label.

(9) Also, in the above (7), the second step (or means) may comprise a step of (or means) informing that the desired MPLS tunnel selected is not permitted if it is not permitted by using the LDP notification message and concurrently sending information of the label of the pseudo wire having the remaining resource and other desired MPLS tunnel candidates which can pass the pseudo wire, to the opposing device in order for the opposing device to select another desired MPLS tunnel from among the candidates, to be re-designated by the LDP label request message.

Namely, as another case of rejection, when returning the LDP notification message from the Egress node to the Ingress node, the Egress node may include a candidate or candidates of MPLS tunnel through which the pseudo wire may be passed so that Egress node may designate the candidate or one of the candidates.

(10) Also, in the above (7), the label distribution request by the LDP label request message may prioritize the desired MPLS tunnels having a remaining resource for a pseudo wire at interfaces having the MPLS tunnels.

Namely, it is also possible that upon initially transmitting the LDP label request message to the Egress node, the Ingress node transmits the information of a plurality of MPLS tunnel candidates assigned with respective priorities through which the pseudo wire is desired to be passed so that Egress node may select an MPLS tunnel through which the pseudo wire is desired to be passed from the candidates, and the MPLS tunnel selected is notified with the LDP label mapping message.

In the above, the information of the MPLS tunnels may comprise an identifier of the MPLS tunnel.

Thus, in a system wherethe accommodating number of PW labels is 100 and the number of interfaces is 10 for example, the accommodatable number of pseudo wires per interface will do by 10, so that useless resources can be eliminated, realizing an assignment of pseudo wires with a low pseudo wire processing capacity and cost.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing schematic operations of a pseudo wire establishing method and device only in one direction for tunnel/pseudo wire;

FIG. 2 is a block diagram showing an overall arrangement of a node that is a pseudo wire establishing device;

FIG. 3 is a block diagram showing an arrangement of a CPU board in the node shown in FIG. 2;

FIG. 4 is a block diagram showing an operation according to Embodiment 1 based on the arrangements shown in FIGS. 2 and 3;

FIG. 5 is a block diagram showing an operation of the Embodiment 1 shown in FIG. 4, including the opposite direction for tunnel/pseudo wire;

FIG. 6 is a flow chart showing an MPLS/PW associated processing on the side of a node N2 in Embodiment 1;

FIGS. 7A and 7B are charts showing management tables of the node N2 in each embodiment;

FIG. 8A and 8B are charts showing a format of LDP label mapping message used in each embodiment;

FIG. 9 is a chart showing a format of “Tunnel TLV” field in the LDP label mapping message shown in FIGS. 8A and 8B;

FIG. 10 is a flow chart showing an MPLS/PW associated processing on the side of a node N1 in Embodiment 1;

FIGS. 11A and 11B are charts showing management tables of the node N1 in each embodiment;

FIGS. 12A-12C are charts showing a format of an LDP notification message used in each embodiment;

FIG. 13 is a block diagram showing an operation of Embodiment 2 based on the arrangements shown in FIGS. 2 and 3;

FIG. 14 is a block diagram showing detailed operations (in both directions) of Embodiment 2;

FIG. 15 is a flow chart showing an MPLS/PW associated processing on the side of a node N1 in the Embodiment 2;

FIG. 16 is a chart showing a format of an LDP label request message used in Embodiment 2;

FIG. 17 is a flow chart showing an MPLS/PW associated processing on the side of a node N2 in Embodiment 2;

FIG. 18 is a block diagram showing a general system arrangement of an MPLS network;

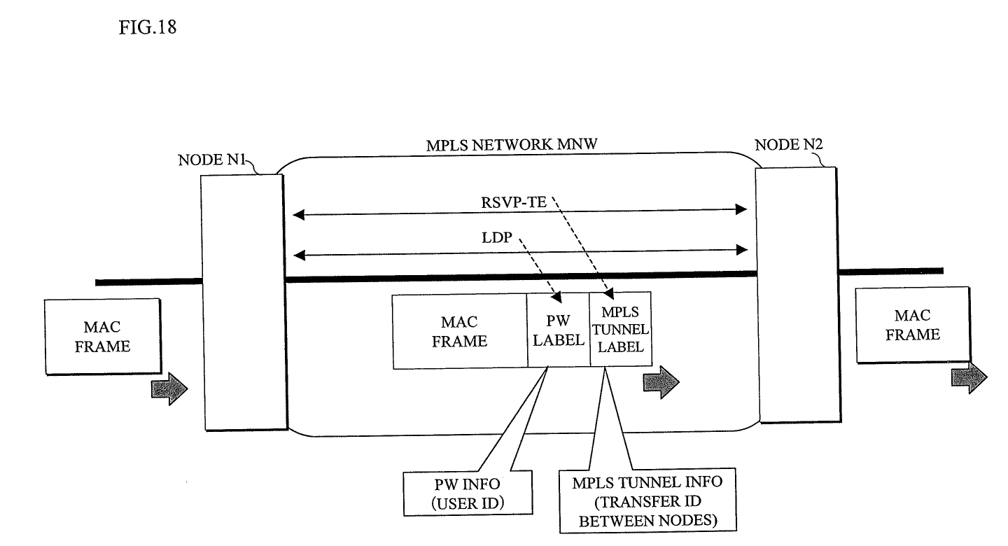

FIG. 19 is a block diagram schematically showing a related art operation in the MPLS network shown in FIG. 18;

FIG. 20 is a block diagram showing an operation of the related art shown in FIG. 19 only in one direction for tunnel/pseudo wire; and

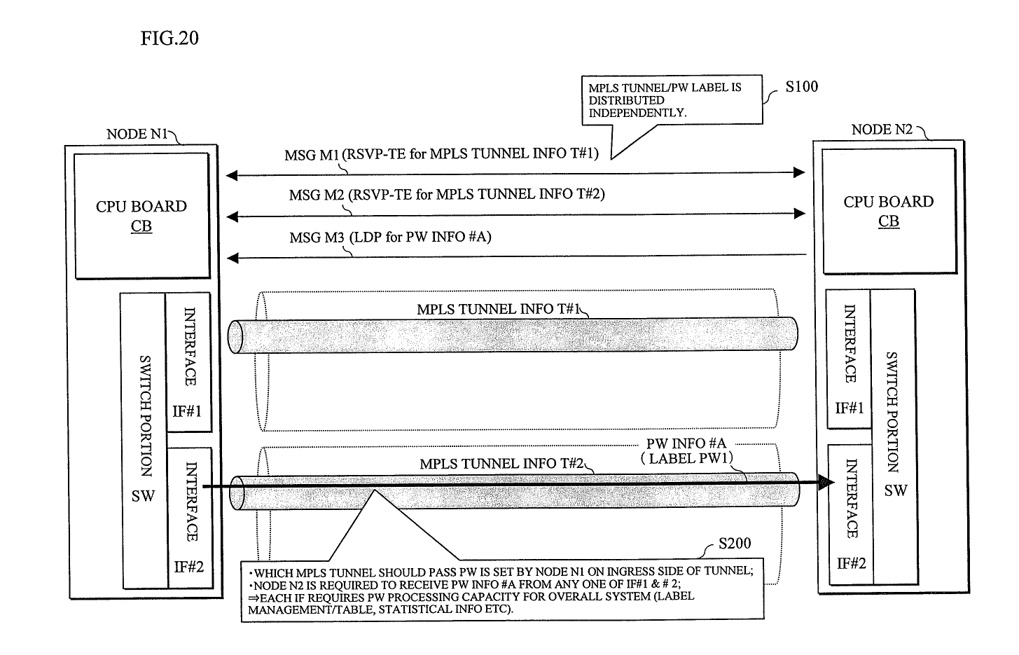

FIG. 21 is a block diagram showing an operation of the related art shown in FIG. 20 in both directions for tunnel/pseudo wire.

### DESCRIPTION OF THE EMBODIMENTS

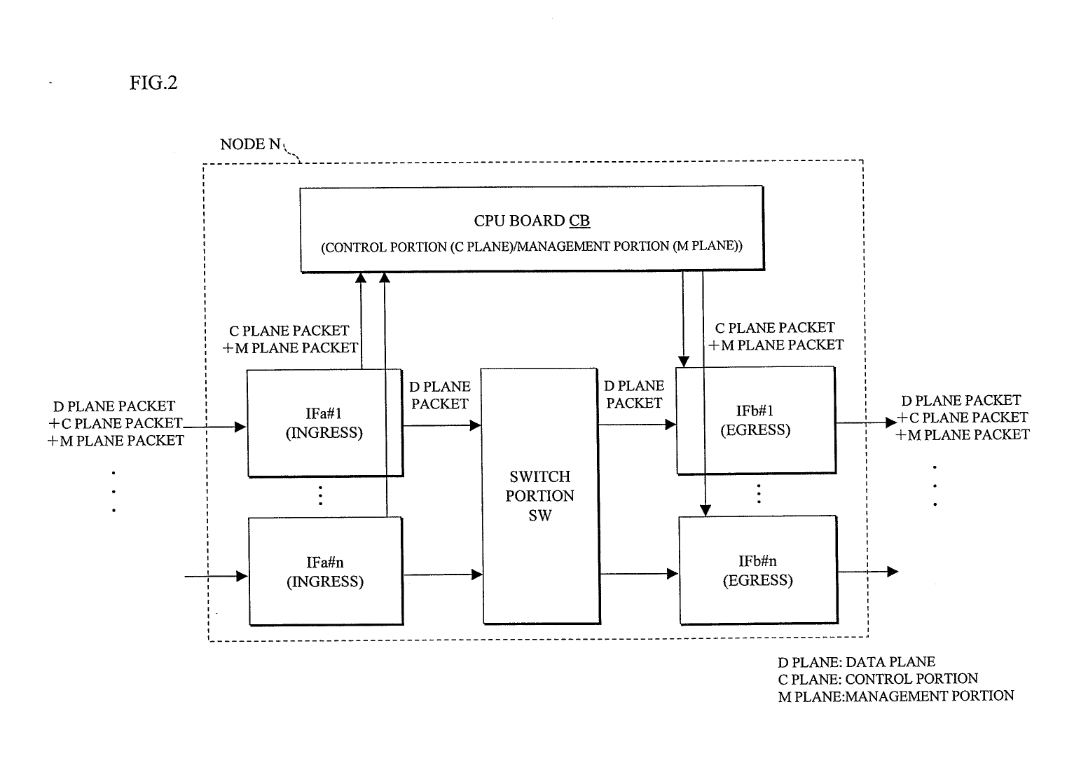

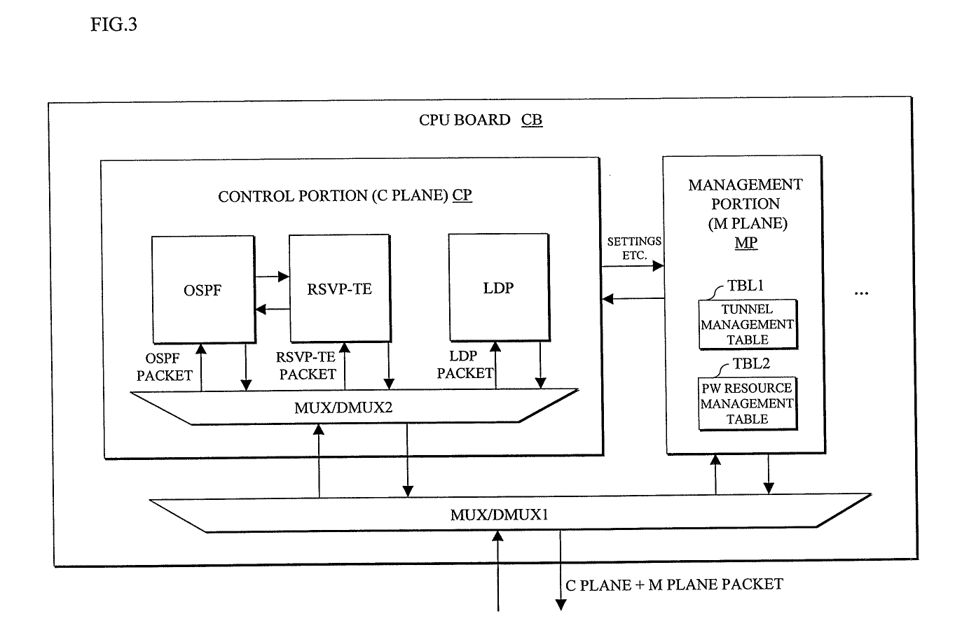

### Device (Node) Arrangement: FIGS. 2 and 3

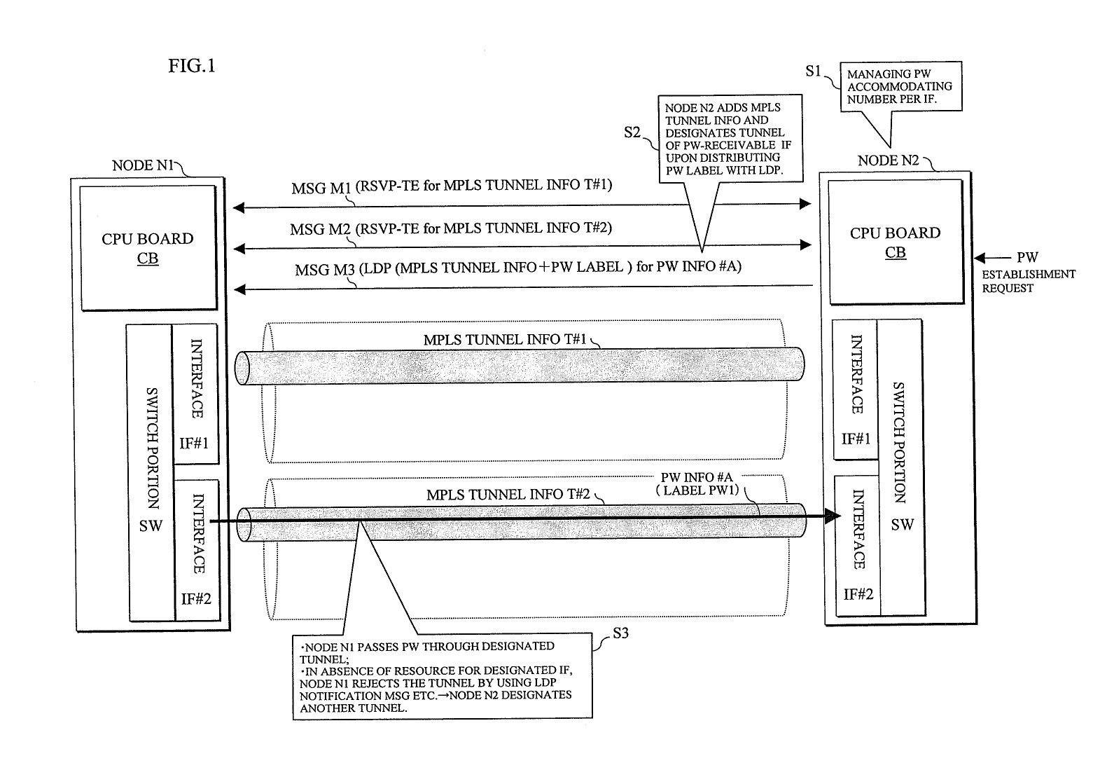

FIG. 2 shows a node N (corresponding to the node N1 or N2 shown in FIG. 1) that is a pseudo wire establishing device. In this example, this node N is arranged to have a signal connection shown among the interfaces (IF), the switch portion SW switching a main signal (Data-plane) between the interfaces (IFa#1-IFa#n-IFb#1-IFb#n) and the CPU board CB for processing the protocols of the control portion (C plane) and the management portion (M plane), where the CPU board CB processes the protocols of RSVP-TE and LDP.

Schematically in operation, the interfaces IFa#l-IFa#n on the Ingress side respectively separate, from the main signal, packets (C plane+M plane packets) for the control portion and the management portion among packets received from external devices to be forwarded to the CPU board CB, where the packets are processed and then transmitted from the interfaces IFb#1-IFb#n on the Egress side.

An arrangement of the CPU board CB is shown in FIG. 3, where software processes within the CPU board CB can be mainly divided into process blocks of the control portion CP and the management portion MP, the control portion CP having therein blocks for processing protocols of OSPF, RSVP-TE, LDP or the like. The management portion MP has functions of reflecting operator's settings to the node, an inter-node status management or resource management etc., and is provided with a tunnel management table TBL1 and a resource management table TBL2, which will be described later.

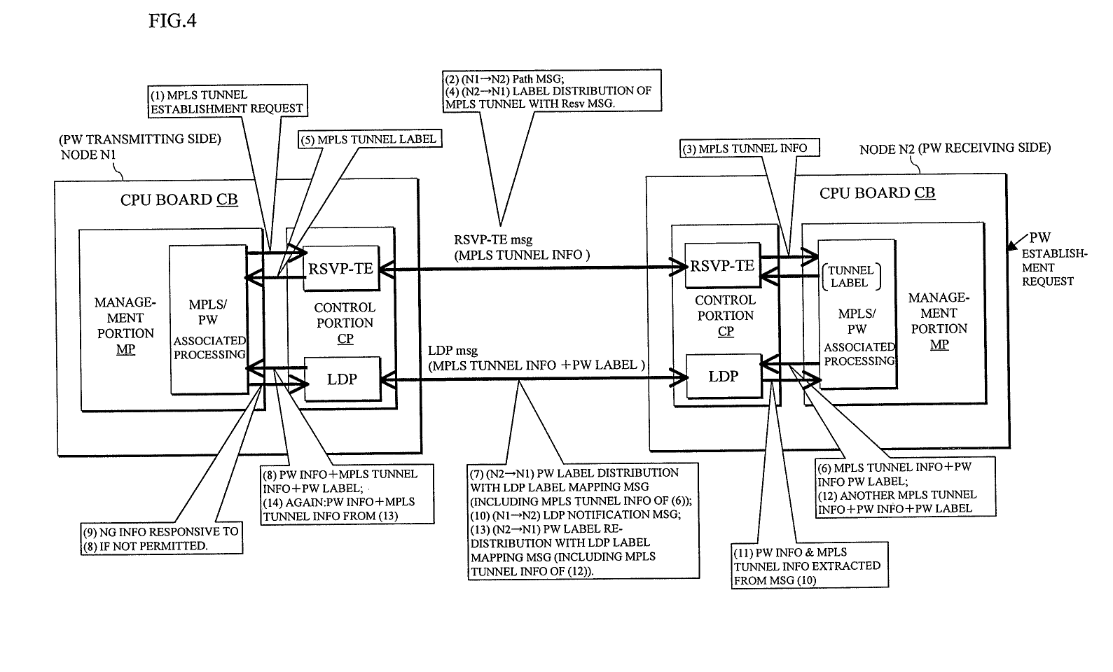

### Embodiment 1: FIGS. 4-12

### [1] Distribution of MPLS Tunnel Label

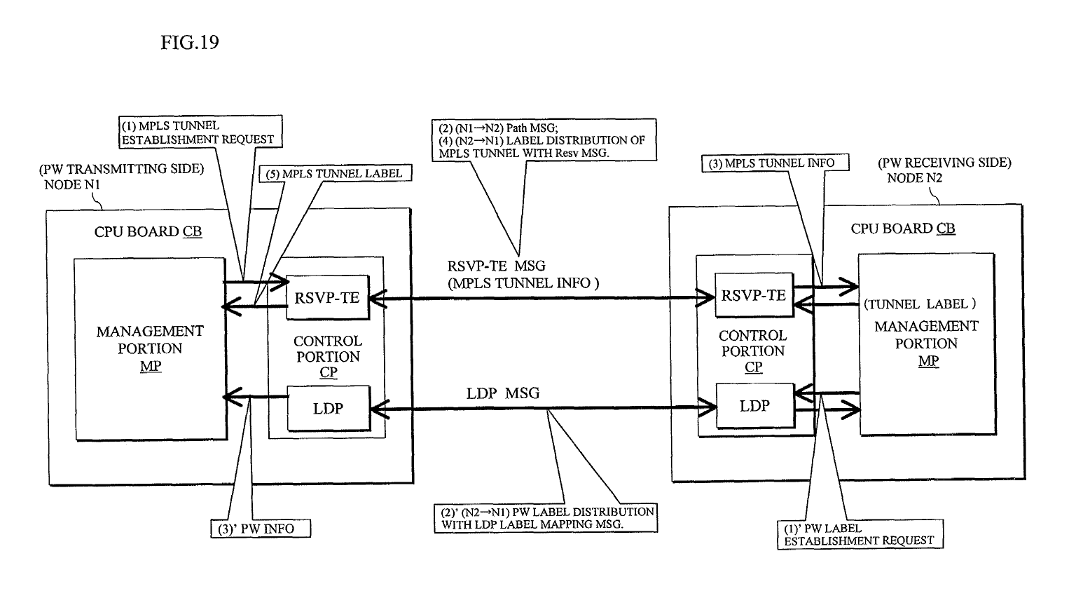

Label distribution processes (1)-(5) of MPLS tunnels shown in FIG. 4 are similar to those of the related art shown in FIG. 19, so that the same descriptions are hereinafter omitted.

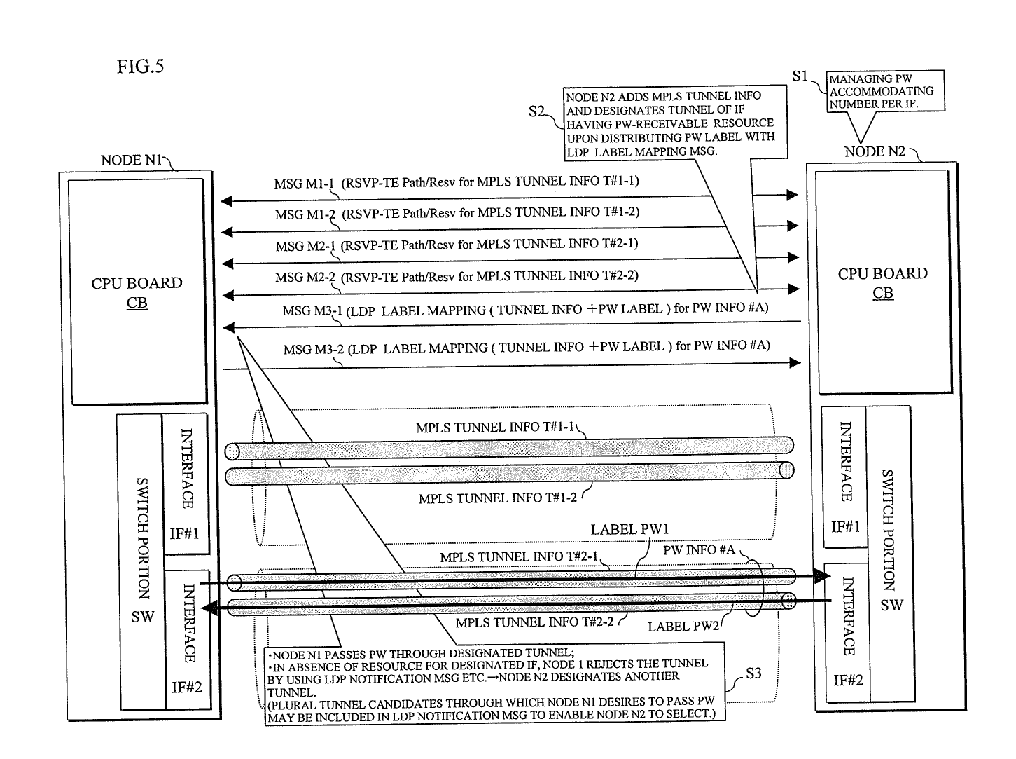

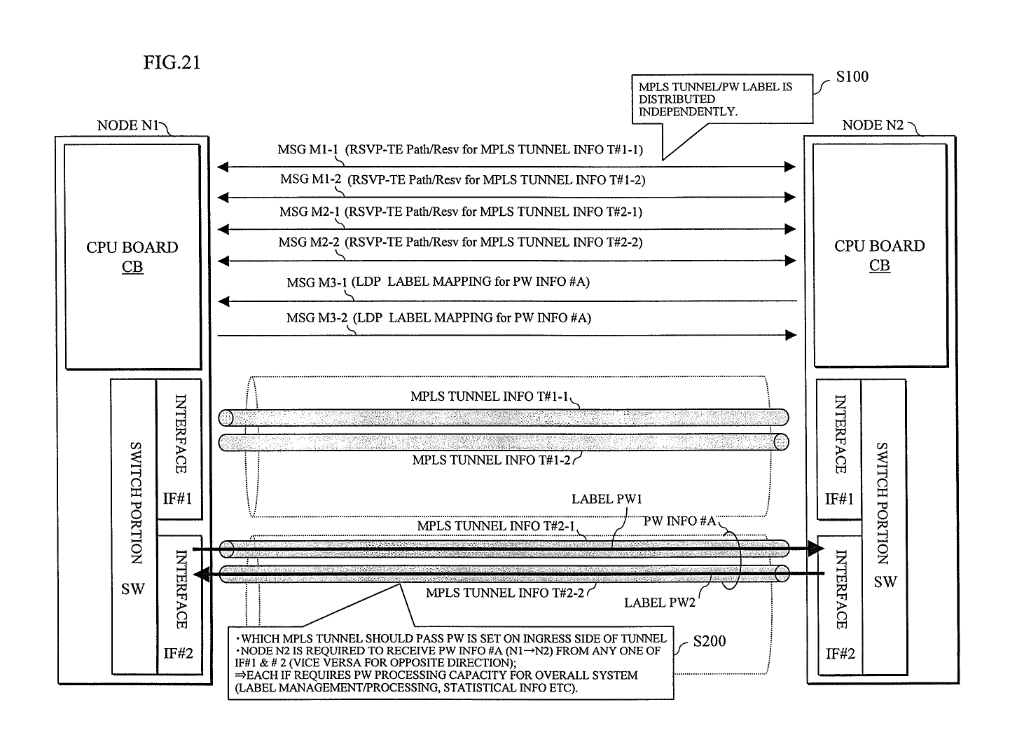

Thus, in FIG. 5, like the related art in FIG. 21, MPLS tunnel labels are distributed in both directions between the nodes N1-N2 with the messages M1-1-M2-2, MPLS tunnels of the MPLS tunnel information T#1-1 and T#1-2 are established between the interfaces IF#1 of the nodes N1 and N2 and MPLS tunnels of the MPLS tunnel information T#2-1 and T#2-2 are established between the interfaces IF#2 similarly.

### [2] Distribution of PW Label

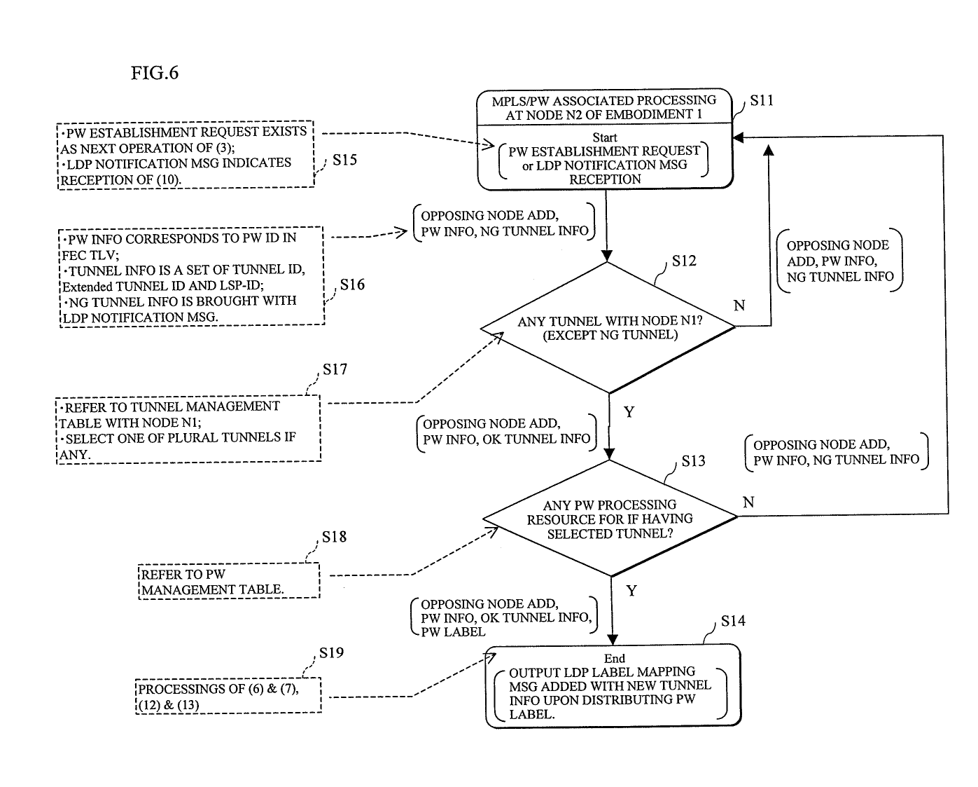

FIG. 6 shows an MPLS/PW associated processing on the side of the node N2 after the MPLS tunnels have been thus established, where as shown in FIG. 4 it is assumed that the node N2 (PW receiving side) receives a PW establishment request at this point. It is to be noted that there is a case that the node N1 also receives a PW establishment request as undermentioned, where which request should be prioritized may be predetermined according to settings for the node. In this embodiment, it is assumed that the PW establishment request is provided only to the node N2 (step S11 in FIG. 6) at this moment (point of process (3) in FIG. 4).

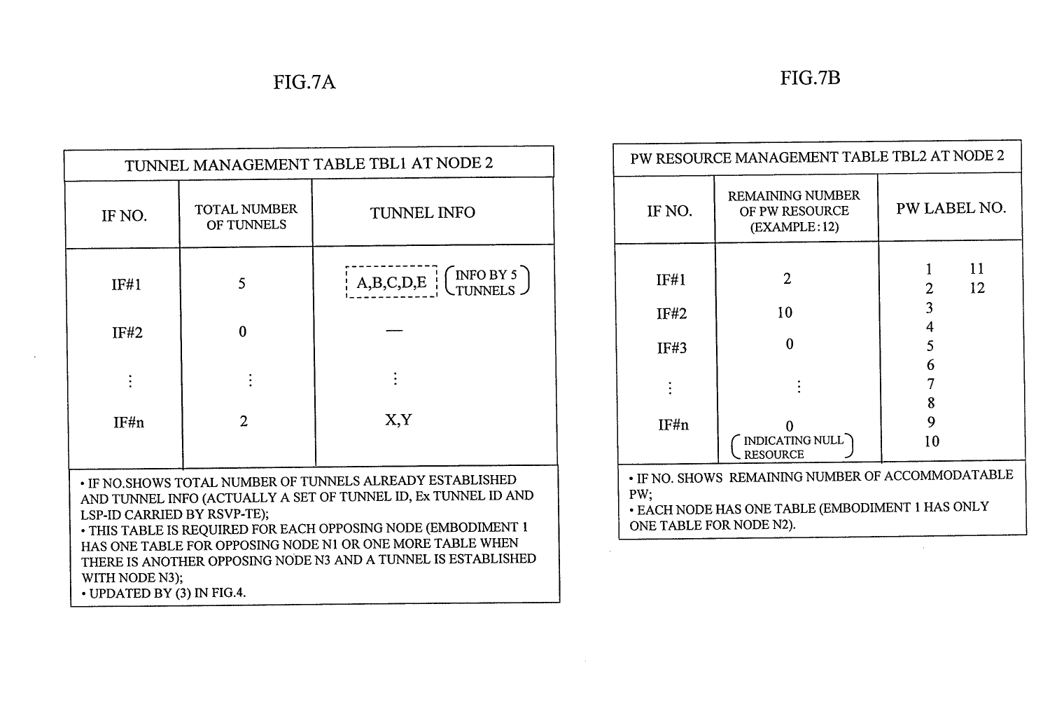

For the distribution process of PW labels, processes (6)-(14) shown are executed. Before doing so, the management portion MP within the CPU board CB of the node N2 determines whether or not a tunnel exists between the nodes N1 and N2 (step S12). This is performed by referring to the tunnel management table TBL1 shown in FIG. 7A. Namely, this tunnel management table TBL1 shows a relationship between tunnel information (actually a combination of tunnel ID, Ex tunnel ID, LSP-ID as tunnel identifiers carried on RSVP-TE) already set for each interface by the above processes (1)-(5) and a total number of the MPLS tunnels, where tunnel information A-E, . . . , X, Y shown in this example include the MPLS tunnel information T#1-1-T#2-2 in FIG. 5. This table TBL1 is required to be provided for each opposing node, where in this example one table is provided for the opposing node N1 and one more table is provided if there exist another opposing node and a tunnel is established with the node. This table TBL1 is updated by the process (3) in FIG. 4.

In this tunnel management table TBL1, if a plurality of tunnels exist therein, one of them is selected (step S17: OK tunnel information) based on a predetermined procedure (for example, predetermined priority order etc.). In the absence of such a tunnel, the process returns to step S11 to repeat the routine.

After one tunnel is selected, it is then checked whether or not there is a processing resource of pseudo wire at the interface having the selected tunnel (step S13). For this purpose, the PW resource management table TBL2 shown in FIG. 7B is retrieved (step S18). This PW resource management table TBL2 shows a remaining number of pseudo wires which the interfaces can accommodate, where each node can have one table but in this embodiment only one table is provided in the node N2.

Since the tunnel management table TBL1 includes the tunnel information A-E, . . . , X, Y (these include the tunnels T#1-1-T#2-2 shown in FIG. 5) preset as above in FIGS. 7A and 7B, assuming that e.g. the tunnel information C among those tunnel information corresponds to the MPLS tunnel information T#1-1 shown in FIG. 5 and is selected by a certain method, the PW resource management table TBL2 will be referred to with respect to the interface IF#1 accommodating the tunnel information C.

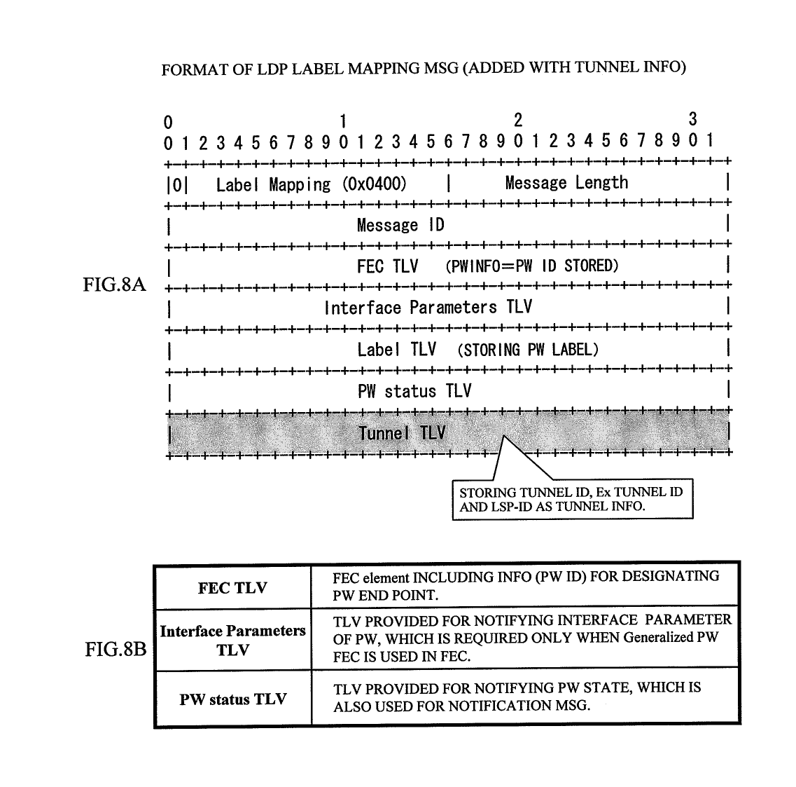

Since the PW resource management table TBL2 shows the PW resource remaining number of the interface IF#1 being 2, that is the interface IF#1 having the tunnel information C has a remaining PW processing resource, a proper one of PW label numbers (=PW label) in the PW resource management table TBL2 in FIG. 7B is selected. It is to be noted that while the PW label numbers are shown as 1-12, assuming that 12 labels remain in this example, and the PW label number can assume 89-100 if there are 100 PW labels in total for example, 1-12 show remaining PW label numbers for the simplification of figure. In the absence of a remaining resource, the routine returns from step S13 to step S11, where the same processes are to be repeated. It is to be noted that a plurality of MPLS tunnels may be selected, preferably with priorities respectively.
(6) The PW label thus selected is sent to the control portion CP together with the MPLS tunnel information (OK tunnel information) and the PW information that is a PW identifier (step S19).
(7) The control portion CP stores the MPLS tunnel information and the PW label thus received in the LDP label mapping message M3-1 shown in FIG. 5 and sends them to the node N1 (step S14). The then format of the LDP mapping message is shown in FIGS. 8A and 8B, where the PW label distributed from the node N2 to the node N1 is stored at “Label TLV” field. Also the PW information as a PW identifier preliminarily obtained from another table (not shown) is stored at “FEC TLV” field.

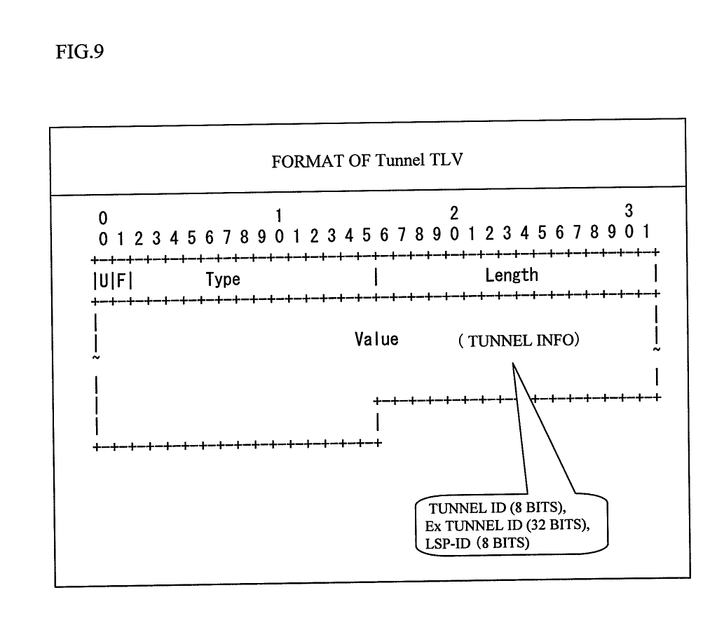

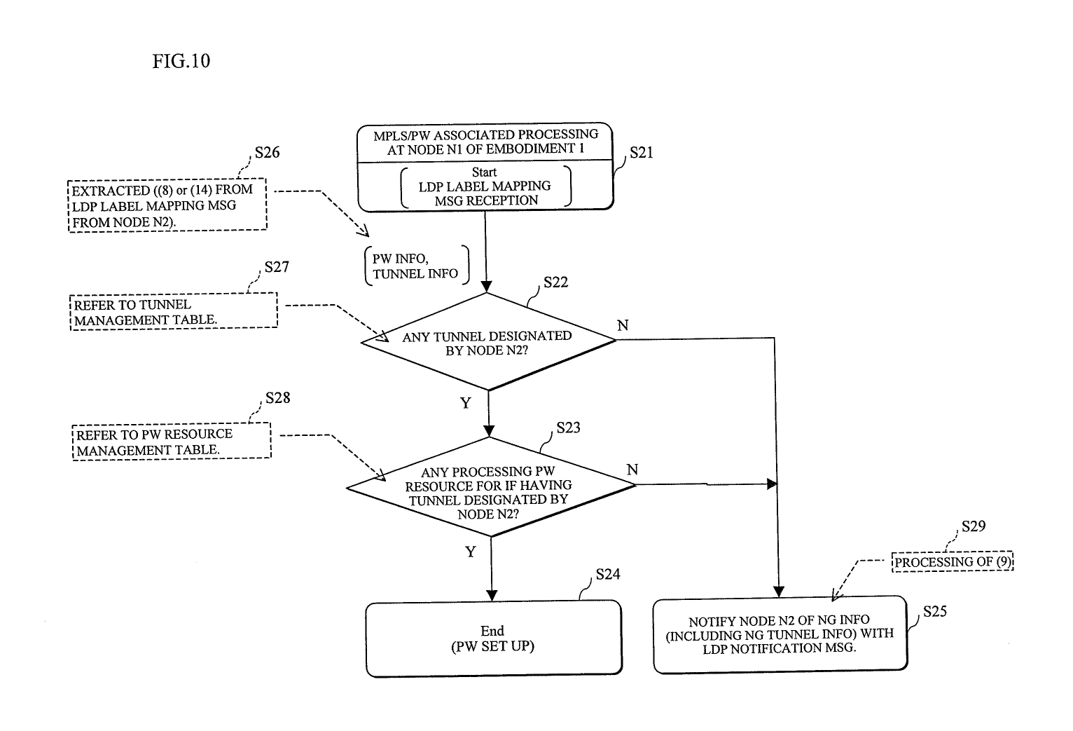

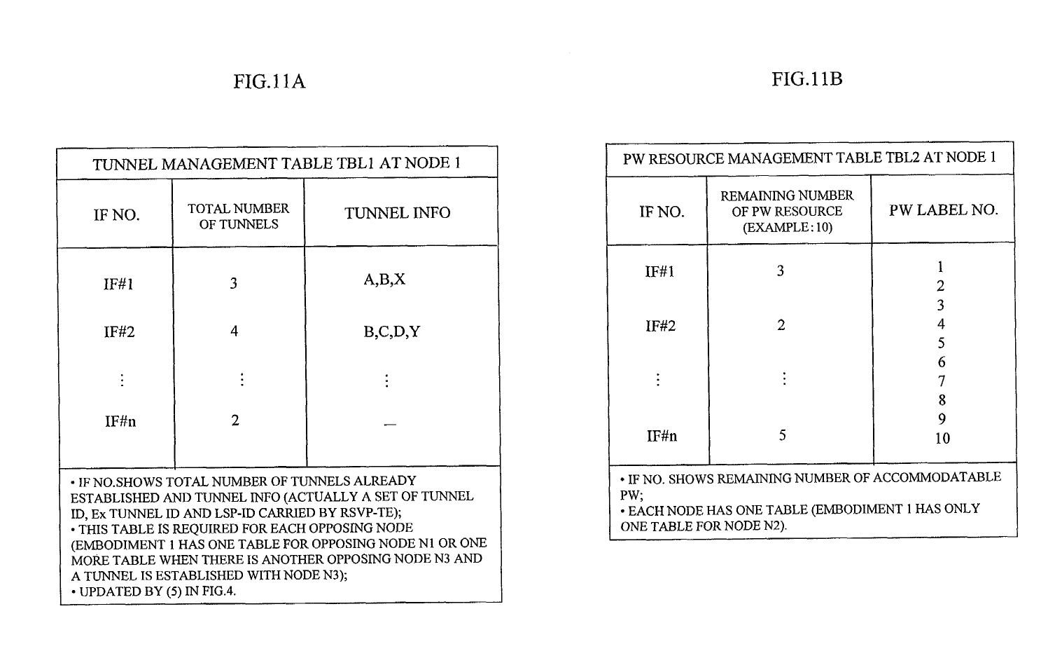

At this time, different from the related art, the tunnel information (including tunnel ID, Ex tunnel ID, LSP-ID) received at the above process (6) is concurrently to be stored at “Tunnel TLV” field added in this embodiment (see FIG. 9), so that the label of the pseudo wire having a remaining resource and the information of MPLS tunnel associated with the label are to be transmitted together (step S19).
(8) Thus, the control portion CP of the node N1 receives the above noted LDP label mapping message M3-1 from the node N2 (step S21 in FIG. 10), extracts the PW information, MPLS tunnel information, and PW label stored in the LDP label mapping message and gives them to the management portion MP (step S26).
(9) The management portion MP determines whether or not it holds a tunnel consistent with the tunnel information designated by the node N2 by referring to the tunnel management table TBL1 provided within the management portion MP of the node N1 shown in FIG. 11A (step S22, S27).

As a result, the MPLS tunnel information C stored at “Tunnel TLV” field shown in FIGS. 8A, 8B and 9 in the LDP label mapping message is included in the tunnel management table TBL1, so that the routine goes to step S23, at which whether or not there is a pseudo wire resource at the interface IF#2 associated with the tunnel information C is determined by referring to the PW resource management table TBL2 shown in FIG. 11B, as with the case in the node N2 (step S23, S28).

As a result, it is found that the PW resource remaining number is 2 at the interface IF#2, so that in the example of FIG. 5 the pseudo wire PW1 is established (step S24). It is to be noted that FIG. 5 shows an example of the opposite direction, where a pseudo wire PW2 is established with the message M3-2.

On the other hand, if the determination result indicates “NO” at step S22 or S23, the routine goes to step S25, where such a notification (NG (No Good) tunnel information) that the MPLS tunnel is not permitted is transmitted to the node N2 with an LDP notification message (step S29).

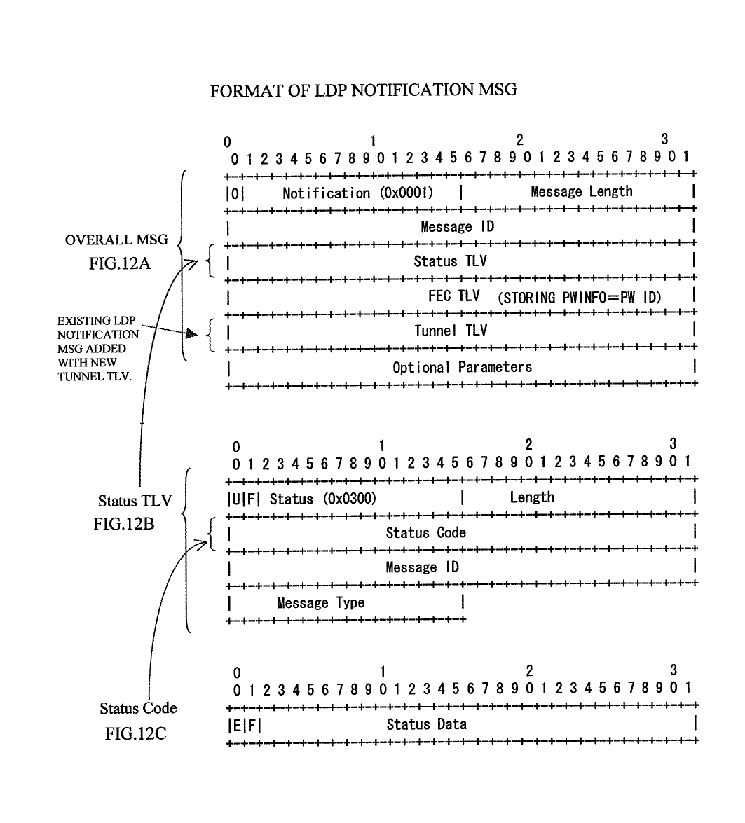

Namely, in the format of the LDP notification message shown in FIGS. 12A-12C, the above contents are stored at “Notification” field and forwarded to the control portion CP (step S325, S29).
(10) The control portion CP forwards the above LDP notification message to the control portion CP of the node N2. This LDP notification message shows at “Notification” field that the MPLS tunnel is not permitted as shown in FIG. 12A, is stored with the PW information at “FEC TLV” field in the same way as the above LDP label mapping message, is stored with the MPLS tunnel information at “Tunnel TLV” field newly added to the existing LDP notification message and is transmitted to the node N2, at which a plurality of MPLS tunnel candidates (preferably assigned with priorities) may be stored at “Tunnel TLV” field.
(11) From the above LDP notification message, the control portion CP of the node N2 extracts the PW information and MPLS tunnel information, recognizes from “Notification” field that it is NG information (indicating the MPLS tunnel is not permitted) (steps S1 , S15, S16 in FIG. 6) and transmits it to the control portion MP.
(12) In response, the control portion MP selects another MPLS tunnel information as well as PW information and PW label as in the above, and provides them to the control portion CP (steps S12, S17, S13, S18).
(13) The control portion CP of the node N2 again distributes or re-distributes a PW label with the LDP label mapping message. At this time, as in the above, new MPLS tunnel information is stored at “Tunnel TLV” field in the LDP label mapping message shown in FIGS. 8 and 9 (step S14).
(14) In response, the control portion CP of the node N1 again provides the PW information, PW label and MPLS tunnel information received from the node N2 to the control portion MP. The control portion MP again executes the MPLS/PW associated processing shown in FIG. 10, where in case of “NO” being determined similarly at step S22 or S23, re-transmitting the LDP notification message at step S25 is repeated. In case of “YES” being determined at steps S22 and S23, a pseudo wire of the PW label is to be passed through the MPLS tunnel in the MPLS tunnel information (step S24).

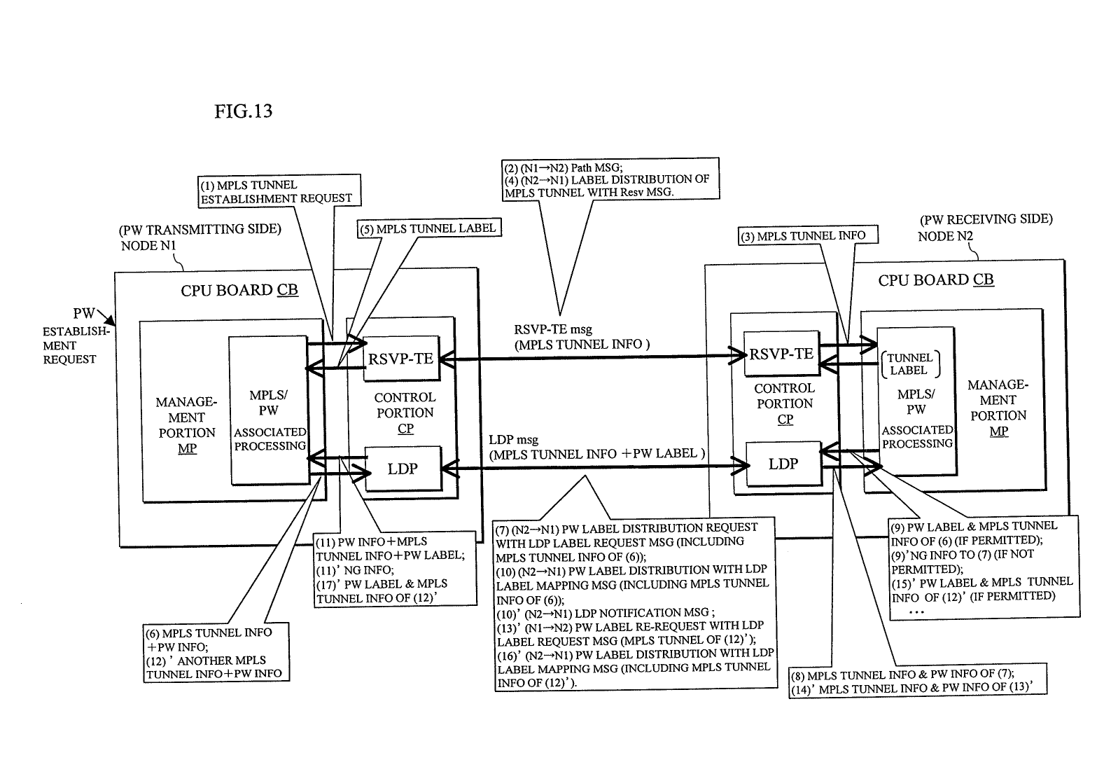

### Embodiment 2: FIGS. 13-17

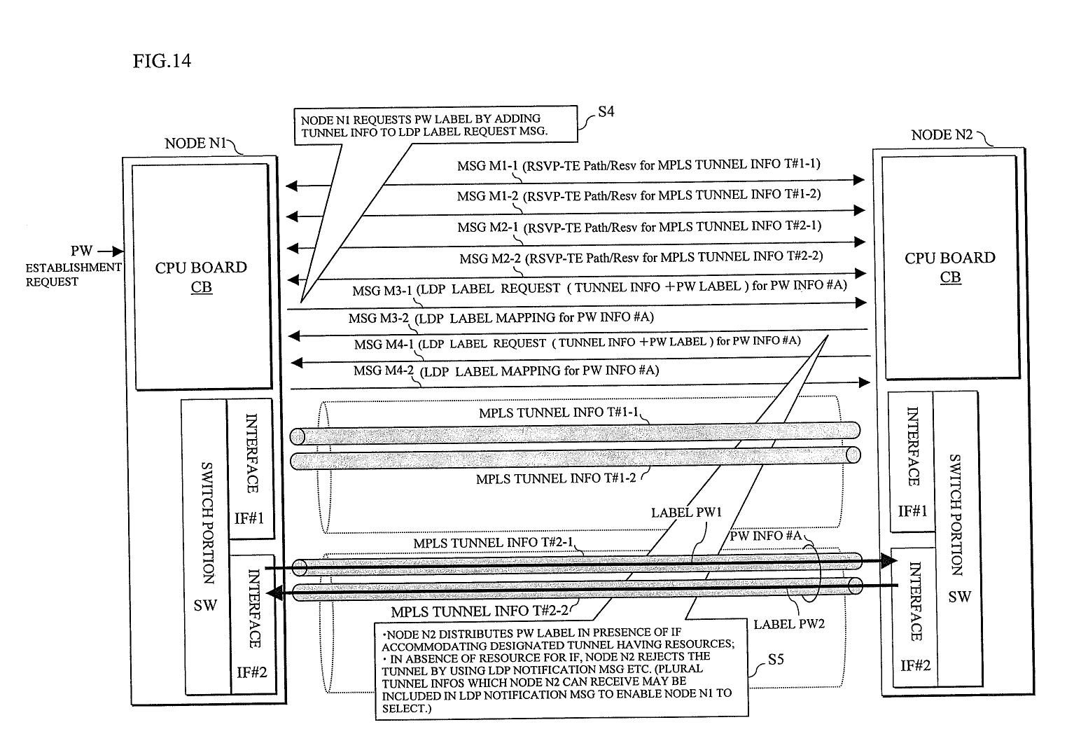

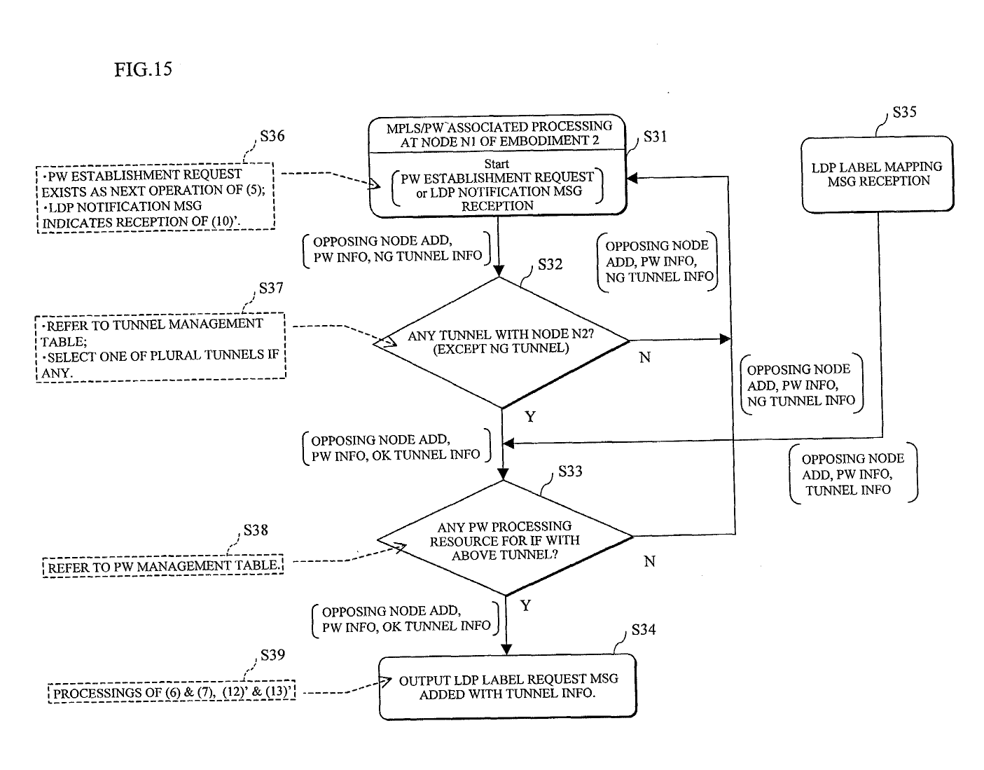

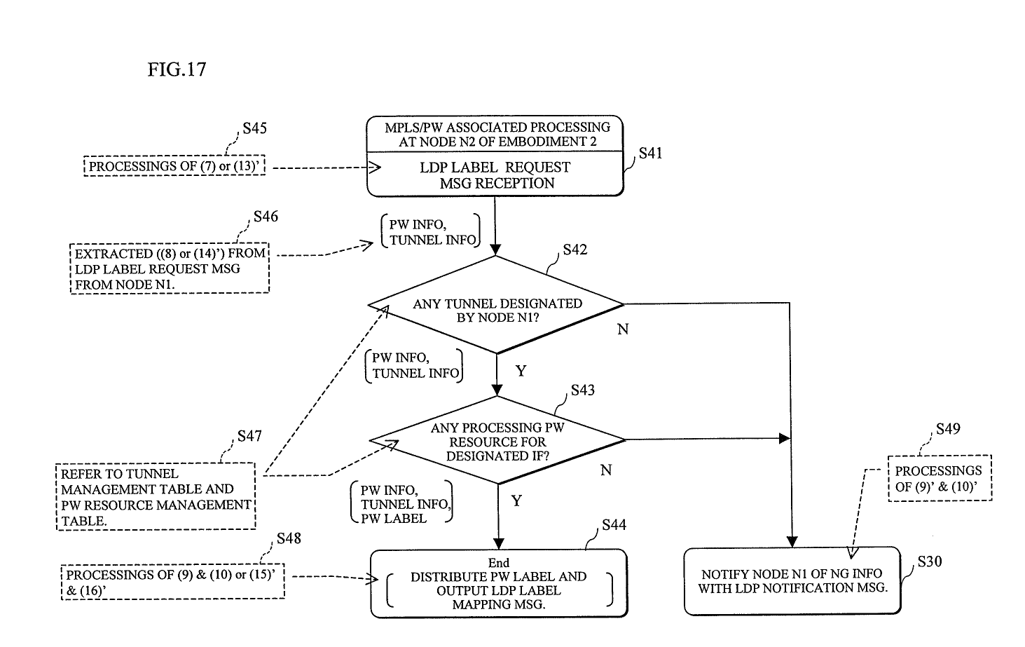

FIG. 13 showing an overall operation according to this Embodiment 2 partially includes the operation of Embodiment 1 shown in FIG. 4 and an operation of FIG. 14 also partially includes the operations shown in FIG. 5 as noted above. Furthermore, an MPLS/PW associated processing on the side of the node N1 shown in FIG. 15 and an MPLS/PW associated processing on the side of the node N2 shown in FIG. 17 in Embodiment 2 respectively correspond to the MPLS/PW associated processings shown in FIGS. 6 and 10 in Embodiment 1.

### [1] Distribution of MPLS Tunnel Labels

At first, in FIG. 13, processes (1)-(5) are the same as those in the distribution of the MPLS tunnel labels shown in FIGS. 4 and 19, so that the same descriptions are hereinafter omitted.

### [2] Distribution of PW Labels

(6) It is assumed in this Embodiment 2 that a PW establishment request is provided to the node N1 after having completed the label distribution of the MPLS tunnels as noted above (step S31, S36). In response to this PW establishment request, the management portion MP determines whether or not an MPLS tunnel exists between the nodes N1 and N2 by referring to the tunnel management tunnel TBL1 shown in FIG. 11A (step S32, S37).

As a result, in the existence of a plurality of tunnels, one of them is selected as with the above Embodiment 1 (step S37), where in this case a plurality of tunnels may be selected. In the absence of those tunnels, the routine returns to step S31 and repeats this processing.

When one (or plural) tunnel is selected, the routine goes to step S33, at which it is determined whether or not there is a processing resource of pseudo wire at the interface having the tunnel selected by referring to the PW resource management TBL2 shown in FIG. 11B (step S33, S38).

The result shows that the PW resource remaining number corresponding to the interface IF#2 with respect to e.g. tunnel information Y is 2, so that the tunnel information Y is selected. Also in this case, a plurality of tunnel information may be selected and priority orders may be assigned to them respectively.

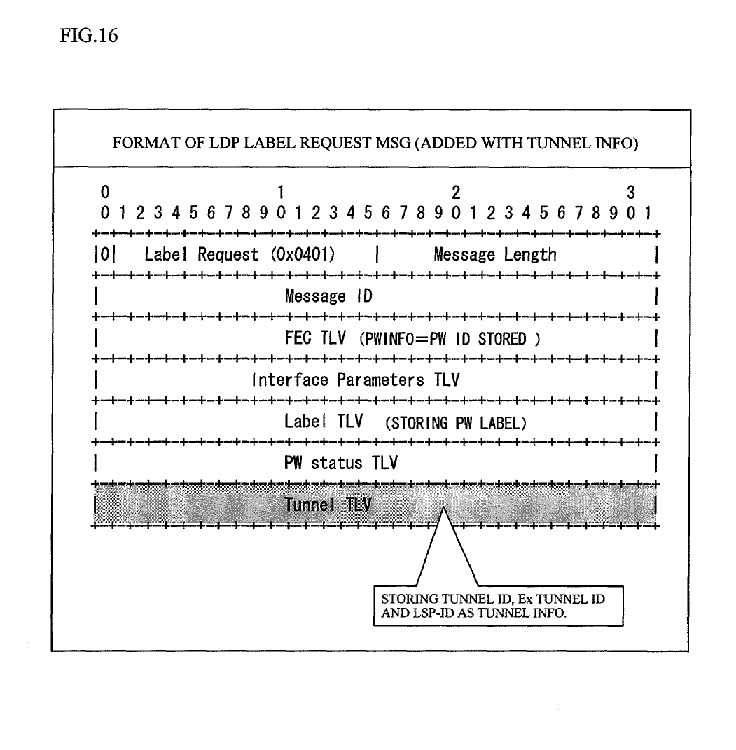

Thus, the PW information indicating the existence of a PW resource together with the MPLS tunnel information are provided from the management portion MP to the control portion CP.
(7) The control portion CP makes a distribution request of PW label with the LDP label request message (step S34, S39). A format of this LDP label request message is shown in FIG. 16, in which it is different from the LDP label mapping message shown in FIGS. 8A and 8B only in that “Label Mapping” field is replaced by “Label Request” field, where the PW information is stored at “FEC TLV” field and the tunnel information is stored at “Tunnel TLV” field, to be transmitted to the node N2.

The LDP label request message of this case is shown as the message M3-1 from the node N1 to the node N2 in FIG. 14 including the tunnel information T#2-1 for the PW information #A.
(8) The control portion CP of the node N2 having received the above LDP label request message executes the MPLS/PW associated processing shown in FIG. 17 (step S41, S45), extracts the PW information and tunnel information, from the LDP label request message, to be informed to the management portion MP.
(9) The management portion MP determines whether or not it holds the tunnel information designated by the node N1 (step S42) and the interface corresponding to the designated tunnel information holds a PW resource (step S43) by referring to the tunnel management table TBL1 and the PW resource management table TBL2 shown in FIGS. 7A and 7B in the same manner as the node N2 in the above Embodiment 1 (step S47).
(10) If the determination result at steps S42 and S43 shows “YES”, the PW label obtained from the PW resource management table TBL2 and the MPLS tunnel information and PW information of the above (6) for passing therethrough the PW label are informed to the control portion CP.
(11) The control portion CP sends the LDP label mapping message M3-2 shown in FIG. 14 having stored therein the above PW label to the node N1 (step S44, S48). At this time, in the LDP label mapping message the permitted (OK) MPLS tunnel information is stored together with the PW label as with the case of Embodiment 1, to be transmitted.
(12) The control portion CP of the node N1 informs the management portion MP of the permitted PW label as well as MPLS tunnel information and PW information from the LDP label mapping message (step S35 in FIG. 15), thereby establishing a pseudo wire of the label PW1. Also in the opposite direction, as shown in FIG. 14, a pseudo wire of label PW2 can be established within the MPLS tunnel T#2-2 by using the messages M4-1 and M4-2.

On the other hand, at step S42 or S43 in FIG. 17, the following steps are executed if the determination of “NO” is made at the node N2:
(9)′ Since the determination “NO” is made at step S42 or S43, the management portion MP of the node N2 gives the control portion CP the NG information with respect to the LDP label request message transmitted by the above (7);
(10)′ In response, the control portion CP transmits the LDP notification message having stored therein the NG information similarly to the above to the node N1 (step S30, S49). The LDP notification message of this case may use the same one as described in the above Embodiment 1;
(11)′ The control portion CP of the node N1 notifies the management portion MP of the NG information with the LDP notification message (step S31, S36);
(12)′ The management portion MP returns to the control portion CP another MPLS tunnel information different from the MPLS tunnel information deemed NG, together with the PW information (step S32, S37, S33, S38). In this case also a plurality of MPLS tunnels may be selected and priority orders may be assigned to them respectively;
(13)′ The control portion CP makes a PW label request to the node N2 by using the LDP label request message again (step S34, S39). At this time, in the LDP label request message, another MPLS tunnel information and PW information of the above (12)′ are stored;
(14)′ The control portion CP of the node N2 extracts the PW information and the MPLS tunnel information from the LDP label request message received and provides them to the management portion MP (step S41, S45, S42 in FIG. 17);
(15)′ The management portion MP executes either of the processings of the above (9) and (9)′;
(16)′ The control portion CP performs the PW label distribution to the node N1 with the LDP label mapping message including the MPLS tunnel information and PW label if the MPLS tunnel information is permitted based on the result of the above (15) or (15)′ (step S42, S47, S43, S44) while if not permitted it informs the rejection with the LDP notification message (step S30, S49);
(17)′ The control portion CP of the node N1 extracts the PW label and MPLS tunnel information from the LDP label mapping message to be transferred to the management portion MP, thereby completing the establishment of a pseudo wire of the PW label.

It is also to be noted that the present invention is not limited by the above-mentioned embodiments, and it is obvious that various modifications may be made by one skilled in the art based on the recitation of the claims.

1. A pseudo wire establishing method comprising:
a first step of establishing MPLS (Multi Protocol Label Switching) tunnels with an opposing device; and
a second step of selecting, from among the established MPLS tunnels, an MPLS tunnel having a remaining resource for passing a pseudo wire at interfaces having the MPLS tunnels in response to a pseudo wire establishment request and of distributing information of the selected MPLS tunnel associated with a label of the pseudo wire having the remaining resource to the opposing device.

2. The pseudo wire establishing method as claimed in claim 1, wherein the first step is executed by RSVP-TE (Resource Reservation Protocol-Traffic Engineering), and the second step comprises a step of storing the information of the selected MPLS tunnel and the label of the pseudo wire associated with the information in an LDP (Label Distribution Protocol) label mapping message in Downstream Unsolicited mode, to be distributed to the opposing device.

3. The pseudo wire establishing method as claimed in claim 2, further comprising a third step of re-selecting, from among the established MPLS tunnels when an LDP notification message received from the opposing device in response to the LDP label mapping message indicates that the selected MPLS tunnel associated with the pseudo wire is not permitted, a second MPLS tunnel having a remaining resource for a pseudo wire at interfaces having the MPLS tunnels and of storing the information of the re-selected MPLS tunnel and the label of the pseudo wire associated with the information in the LDP label mapping message, to be distributed to the opposing device.

4. The pseudo wire establishing method as claimed in claim 2, further comprising a third step of re-selecting, from among MPLS tunnel candidates when the LDP notification message received from the opposing device in response to the LDP label mapping message indicates that the selected MPLS tunnel associated with the pseudo wire is not permitted and designates the MPLS tunnel candidates through which the pseudo wire is desired to be passed, a second MPLS tunnel having a remaining resource for a pseudo wire at interfaces having the MPLS tunnels and of storing the information of the re-selected MPLS tunnel and the label of the pseudo wire associated with the information in the LDP label mapping message, to be distributed to the opposing device.

5. The pseudo wire establishing method as claimed in claim 1, wherein the second step comprises a step of selecting, from among the established MPLS tunnels, a plurality of MPLS tunnels respectively assigned with priorities each having a remaining resource for a pseudo wire at interfaces having the MPLS tunnels, to be distributed to the opposing device in order for the opposing device to select one of the MPLS tunnels in accordance with the priorities.

6. A pseudo wire establishing method comprising:
a first step of establishing MPLS tunnels with an opposing device; and
a second step of selecting, from among desired MPLS tunnels when a label distribution request for a pseudo wire to be passed through the desired MPLS tunnels is received from the opposing device having received a pseudo wire establishment request, an MPLS tunnel having a remaining resource for a pseudo wire at interfaces having the MPLS tunnels and of distributing information of the selected MPLS tunnel associated with a label of the pseudo wire having the remaining resource to the opposing device.

7. The pseudo wire establishing method as claimed in claim 6, wherein the first step is executed by RSVP-TE (Resource Reservation Protocol-Traffic Engineering), and when the label distribution request is made by using an LDP label request message in Downstream on Demand mode the second step comprises storing the information of the selected MPLS tunnel and the label of the pseudo wire associated with the information in an LDP label mapping message in Downstream Unsolicited mode, to be distributed to the opposing device.

8. The pseudo wire establishing method as claimed in claim 7, wherein the second step comprises a step of informing that the desired MPLS tunnel selected is not permitted if it is not permitted, to the opposing device by using the LDP notification message in order for the opposing device to re-designate another desired MPLS tunnel by using the LDP label request message.

9. The pseudo wire establishing method as claimed in claim 7, wherein the second step comprises a step of informing that the desired MPLS tunnel selected is not permitted if it is not permitted by using the LDP notification message and concurrently sending information of the label of the pseudo wire having the remaining resource and other desired MPLS tunnel candidates which can pass the pseudo wire, to the opposing device in order for the opposing device to select another desired MPLS tunnel from among the candidates, to be re-designated by the LDP label request message.

10. The pseudo wire establishing method as claimed in claim 7, wherein the label distribution request by the LDP label request message prioritizes the desired MPLS tunnels having a remaining resource for a pseudo wire at interfaces having the MPLS tunnels.

11. A pseudo wire establishing device comprising:
a first means establishing MPLS (Multi Protocol Label Switching) tunnels with an opposing device; and
a second means selecting, from among the established MPLS tunnels, an MPLS tunnel having a remaining resource for passing a pseudo wire at interfaces having the MPLS tunnels in response to a pseudo wire establishment request and of distributing information of the selected MPLS tunnel associated with a label of the pseudo wire having the remaining resource to the opposing device.

12. The pseudo wire establishing device as claimed in claim 11, wherein the first means is executed by RSVP-TE (Resource Reservation Protocol-Traffic Engineering), and the second means comprises a means storing the information of the selected MPLS tunnel and the label of the pseudo wire associated with the information in an LDP (Label Distribution Protocol) label mapping message in Downstream Unsolicited mode, to be distributed to the opposing device.

13. The pseudo wire establishing device as claimed in claim 12, further comprising a third means re-selecting, from among the established MPLS tunnels when an LDP notification message received from the opposing device in response to the LDP label mapping message indicates that the selected MPLS tunnel associated with the pseudo wire is not permitted, a second MPLS tunnel having a remaining resource for a pseudo wire at interfaces having the MPLS tunnels and of storing the information of the re-selected MPLS tunnel and the label of the pseudo wire associated with the information in the LDP label mapping message, to be distributed to the opposing device.

14. The pseudo wire establishing device as claimed in claim 12, further comprising a third means re-selecting, from among MPLS tunnel candidates when the LDP notification message received from the opposing device in response to the LDP label mapping message indicates that the selected MPLS tunnel associated with the pseudo wire is not permitted and designates the MPLS tunnel candidates through which the pseudo wire is desired to be passed, a second MPLS tunnel having a remaining resource for a pseudo wire at interfaces having the MPLS tunnels and of storing the information of the re-selected MPLS tunnel and the label of the pseudo wire associated with the information in the LDP label mapping message, to be distributed to the opposing device.

15. The pseudo wire establishing device as claimed in claim 11, wherein the second means comprises a means selecting, from among the established MPLS tunnels, a plurality of MPLS tunnels respectively assigned with priorities each having a remaining resource for a pseudo wire at interfaces having the MPLS tunnels, to be distributed to the opposing device in order for the opposing device to select one of the MPLS tunnels in accordance with the priorities.

16. A pseudo wire establishing device comprising:
a first means establishing MPLS tunnels with an opposing device; and
a second means selecting, from among desired MPLS tunnels when a label distribution request for a pseudo wire to be passed through the desired MPLS tunnels is received from the opposing device having received a pseudo wire establishment request, an MPLS tunnel having a remaining resource for a pseudo wire at interfaces having the MPLS tunnels and of distributing information of the selected MPLS tunnel associated with a label of the pseudo wire having the remaining resource to the opposing device.

17. The pseudo wire establishing device as claimed in claim 16, wherein the first means is executed by RSVP-TE (Resource Reservation Protocol-Traffic Engineering), and when the label distribution request is made by using an LDP label request message in Downstream on Demand mode the second means comprises storing the information of the selected MPLS tunnel and the label of the pseudo wire associated with the information in an LDP label mapping message in Downstream Unsolicited mode, to be distributed to the opposing device.

18. The pseudo wire establishing device as claimed in claim 17, wherein the second means comprises a means informing that the desired MPLS tunnel selected is not permitted if it is not permitted, to the opposing device by using the LDP notification message in order for the opposing device to re-designate another desired MPLS tunnel by using the LDP label request message.

19. The pseudo wire establishing device as claimed in claim 17, wherein the second means comprises a means informing that the desired MPLS tunnel selected is not permitted if it is not permitted by using the LDP notification message and concurrently sending information of the label of the pseudo wire having the remaining resource and other desired MPLS tunnel candidates which can pass the pseudo wire, to the opposing device in order for the opposing device to select another desired MPLS tunnel from among the candidates, to be re-designated by the LDP label request message.

20. The pseudo wire establishing device as claimed in claim 17, wherein the label distribution request by the LDP label request message prioritizes the desired MPLS tunnels having a remaining resource for a pseudo wire at interfaces having the MPLS tunnels.
